(19) United States
(12) Patent Application Publication
(10) Pub. No.: US 2019/0216096 A1
(43) Pub. Date: Jul. 18, 2019

(54) APPARATUS AND METHOD FOR QUICK AND PRECISE DOSING OF FLOUR

(71) Applicant: Ingen Robotics Pvt. Ltd., Kollam (IN)

(72) Inventors: Rejin NARAYANAN-SAROJA, Kollam (IN); Binus Mohanan THANKAMONY, Kollam (IN)

(21) Appl. No.: 16/246,429

(22) Filed: Jan. 11, 2019

(30) Foreign Application Priority Data
Jan. 12, 2018 (IN) 201841001377

(51) Int. Cl. A21C 1/14; A21C 1/06; A21D 13/43; A21B 7/00

(52) U.S. Cl. CPC A21C 1/1425; A21C 1/065; A21B 7/005; A21D 13/43; A21C 1/146

(57) ABSTRACT

The present disclosure provides an apparatus for dispensing powdered material, including container for storing powdered material. The container includes inlet for receiving powdered material and outlet for dispensing powdered material. A screw conveyor member disposed within container, which includes a first end rotatably mounted on wall of container and a second end abuttingly positioned to outlet and is operable by actuator for conveying powdered material through outlet. A scattering member, which includes at least one obstruction, is coupled to outlet, for scattering powdered material from outlet during dispensing operation. A load sensor adapted to support container for measuring weight of container. A control module adapted to control operating speed of actuator to operate screw conveyor member in a plurality of rotating modes based on weight readings received from load sensor. The apparatus prevents formation of chunks while dispensing powdered substance and thereby ensure precise dispensing of powdered material.

### CROSS REFERENCE TO RELATED APPLICATIONS

This application claims priority to Indian provisional patent application No. 201841001377, filed Jan. 12, 2018, which is incorporated herein in its entirety by this reference thereto.

### TECHNICAL FIELD

The present disclosure relates to an apparatus and a method for dispensing a powdered material, more particularly, to an apparatus and methods for dispensing flour in a flatbread making apparatus.

### BACKGROUND

Baking is an art of cooking food, wherein the food is heated or baked at a predetermined temperature using an oven. The temperature may be set based on the type of food to be prepared and the ingredients used. The food that is typically prepared by baking a flatbread may be one of a chapati, a tortilla, a pita bread, a crepe and the like. Baking the food may require precise judgement of a cook, for optimum cooking. Apart from the instincts and skill of the cook, one of the primary parameters which impacts baking is the amount of dough used or dosing of flour, for cooking the food.

To enhance accuracy of the flour used for cooking the flatbread, technology is paving way for automated dosing devices, which are configured to dose required quantity of flour for baking the food. These automated dosing devices are configured to automatically dose the required quantity of the flour once an input is received from the user. However, these automated dosing devices fail to consider the aspect of formation of chunks of flour due to inherent binding nature of the flour particles. Thus, these automated dosing devices may dispense chunks of the flour directly, instead of granulated flour, which makes the dispensed volume largely inaccurate than the required quantity of flour. This scenario ruins the entire baking process, which is undesirable. Additionally, the trending devices used for automatically dispensing the flour are typically expensive, complex in construction and require high degree of maintenance.

Therefore, there is a need for techniques for dispensing the flour, which can overcome one or more limitations stated above in addition to providing other technical advantages.

The information disclosed in this background section is only for enhancement of understanding of the general background of the invention and should not be taken as an acknowledgment that this information forms the prior art already known to a person skilled in the art.

### SUMMARY

Various embodiments of the present disclosure provide an apparatus for dispensing a powdered material. The apparatus includes a container for storing the powdered material. The container includes an inlet for receiving the powdered material and an outlet for dispensing the powdered material. A screw conveyor member is disposed within the container. The screw conveyor member includes a first end rotatably mounted on a wall of the container and a second end abuttingly positioned to the outlet, wherein the screw conveyor member is operable by an actuator for conveying the powdered material through the outlet of the container. The apparatus further includes a scattering member having at least one obstruction. The configuration of each of the at least one obstruction comprises one of a flat surface configuration, a twisted configuration and an S-shaped configuration. The scattering member is coupled to the outlet for scattering the powdered material while dispensing the powdered material from the outlet of the container. The apparatus further includes a load sensor mounted on a frame member and adapted to support the container for measuring weight of the container. A control module is adapted to control operating speed of the actuator to operate the screw conveyor member in a plurality of rotating modes based on weight readings received from the load sensor, for controlling dispensing of the powdered material based on the plurality of rotating modes.

The control module is configured to compute a predetermined quantity of the powdered material required to be dispensed, and to divide the predetermined quantity into a first portion, a second portion and a third portion. In a first mode of the plurality of rotating modes, the first portion is dispensed, by operating the screw conveyor member for a predetermined duration of time. In a second mode of the plurality of rotating modes, the second portion is dispensed, by operating the screw conveyor member, until the second portion is determined by the control module based on changes in readings provided by the load sensor based on difference in weight of the container. In a third mode of the plurality of rotating modes, the third portion is dispensed by operating the screw conveyor member intermittently, until the third portion is determined by the control module based on changes in readings provided by the load sensor based on difference in weight of the container. The third portion is divided into a plurality of sub-portions and the weight of the container is subsequently monitored, upon dispensing of each of the plurality of sub-portions intermittently, until the third portion of the predetermined quantity is dispensed from the container. The screw conveyor member is operated at a first speed, a second speed and a third speed for the first mode, the second mode, and the third mode of the plurality of rotating modes, respectively.

The present disclosure also provides an apparatus for dispensing a powdered material. The apparatus includes a container for storing the powdered material. The container includes an inlet for receiving the powdered material and an outlet for dispensing the powdered material. The screw conveyor member is disposed within the container. The screw conveyor member includes a first end rotatably mounted on a wall of the container and a second end positioned juxtaposed to the outlet, wherein the screw conveyor member is operable by an actuator for conveying the powdered material through the outlet of the container. The apparatus further includes a scattering member having a plurality of obstructions. The scattering member is coupled to the second end of the screw conveyer member and positioned proximal to the outlet for scattering the powdered material while dispensing the powdered material from the outlet of the container. The apparatus further includes a load sensor adapted to support the container for measuring weight of the container. A control module adapted to control operating speed of the actuator to operate the screw conveyor member in a plurality of rotating modes based on weight readings received from the load sensor to control dispensing of the powdered material based on the plurality of rotating modes. The apparatus also includes a rotary encoder coupled to the screw conveyer member for determining angular position of the screw conveyor member during each of the plurality of rotating modes. The rotary encoder is electronically coupled to the control module for sending readings, for controlling operation of the screw conveyor member.

The present disclosure further provides a flatbread making apparatus. The flatbread making apparatus includes an apparatus for dispensing flour, which further includes a container for storing the flour. The container includes an inlet for receiving the flour and an outlet for dispensing the flour. The screw conveyor member is disposed within the container, which includes a first end rotatably mounted on a wall of the container and a second end positioned within the outlet. Further, the screw conveyor member is operable by an actuator for conveying the flour through the outlet of the container. The apparatus further includes a scattering member, which is at least partially disposed within the outlet, coupled to the second end of the screw conveyer member. The scattering member includes a plurality of obstructions for scattering the flour while dispensing the flour from the outlet of the container. The apparatus includes a load sensor adapted to support the container for measuring weight of the container. A mixer unit positioned juxtaposed below the container and configured to receive the scattered flour routed through the outlet of the container and to knead the scattered flour into a doughball. A control module is electronically coupled to the actuator and adapted to control operating speed of the actuator for operating the screw conveyor member in a plurality of rotating modes based on weight reading received from the load sensor to controlling dispensing of the powdered material based on the plurality of rotating modes. Further, the apparatus includes a mechanism to bake flatbread from the doughball received from the mixer unit.

Other aspects and exemplary embodiments are provided in the drawings and the detailed description that follows.

### BRIEF DESCRIPTION OF THE FIGURES

The following detailed description of illustrative embodiments is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers:

FIG. 1 is a perspective view of an apparatus for dispensing a powdered material, in accordance with an exemplary embodiment of the present disclosure;

FIG. 2 is a simplified schematic representation of the apparatus of FIG. 1 showing a screw conveyor member and a scattering member mounted to an outlet, in accordance with an exemplary embodiment of the present disclosure;

FIG. 3A is a simplified schematic representation of the apparatus of FIG. 1 showing the screw conveyor member and a scattering member coupled to the screw conveyor member in accordance with an exemplary embodiment of the present disclosure;

FIG. 3B is a simplified schematic representation of the apparatus of FIG. 1 showing the screw conveyor member and a scattering member coupled to the screw conveyor member in accordance with another exemplary embodiment of the present disclosure;

FIG. 4 is a schematic representation of the apparatus illustrating the screw conveyor member conveying the powdered material to an outlet, in accordance with an exemplary embodiment of the present disclosure;

FIGS. 5A to 5F are schematic representations of scattering members of the apparatus of FIG. 1, in accordance with an some exemplary embodiments of the present disclosure; and

FIG. 6 is a schematic representation of a flatbread making apparatus including the apparatus of FIG. 1, in accordance with an exemplary embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various embodiments of the present disclosure provide an apparatus for dispensing a powdered material. The apparatus is configured to scatter a powdered material while dispensing from a container, so that the dispensed powdered material is devoid of chunks or lumps, thereby ensuring accurate and precise dispensing of the powdered material. The powdered material may be flour, used for making flatbreads.

The apparatus includes the container for storing the powdered material. The container includes an inlet for receiving the powdered material and an outlet for dispensing the powdered material. The inlet is provided on a top surface of the container, while the outlet is provided towards bottom of the container. A screw conveyor member is disposed within the container, wherein the screw conveyor member includes a first end rotatably mounted on a wall of the container and a second end positioned proximal, for example abutting to the outlet of the container. The screw conveyor member is operable by an actuator for conveying the powdered material from the container through the outlet of the container. In an embodiment, the screw conveyor member may be positioned within the outlet of the container, for ease of dispensing the powdered material from the outlet of the container. The apparatus includes a scattering member comprising at least one obstruction and coupled to the outlet for scattering the powdered material while dispensing the powdered material from the outlet of the container. In another exemplary embodiment, the scattering member can be coupled to the second end of the screw conveyer member. The scattering member is positioned proximal to the outlet for scattering the powdered material while dispensing the powdered material.

The apparatus also includes a load sensor on which container is mounted, and it supports the container for measuring weight of the container. A control module is electronically coupled to the actuator and is adapted to control operating speed of the actuator to operate the screw conveyor member in a plurality of rotating modes based on weight reading received from the load sensor to control dispensing of the powdered material based on the plurality of rotating modes.

In an embodiment, the apparatus includes a rotary encoder coupled to the screw conveyer member for determining angular position of the screw conveyor member during each of the plurality of rotating modes. The rotary encoder is electronically coupled to the control module for sending readings, for controlling operation of the screw conveyor member.

The apparatus for dispensing the powdered material may be suitable in applications where dispensing of powdered material is required. For instance, in an example, the apparatus may be used for dispensing a powdered material such as flour in a flatbread making apparatus.

The terms ‘powdered material’ and ‘flour’ are used interchangeably throughout the present disclosure, and both terms refer to the same material or type of substance, unless the context suggests otherwise.

The present disclosure also discloses a technique for dispensing a powdered material from the apparatus. The technique includes operating the screw conveying member by the control module via the actuator in a plurality of rotating modes. In the first mode of the plurality of rotating modes, for a predetermined duration of time, a first portion of the powdered material is dispensed. In the second mode of the plurality of rotating modes, the screw conveying member is subsequently operated by the control module for dispensing a second portion of the powdered material, wherein the second portion is determined by the control module based on the weight of the container determined by the load sensor. In the third mode of the plurality of rotating modes, the screw conveying member is then intermittently operated by the control module for dispensing a third portion of the powdered material, the third portion is determined by the control module based on the weight of the container determined by the load sensor. The first portion, the second portion and the third portion are determined by the control module as per the predetermined quantity of the powdered material that is required to be dispensed by the apparatus.

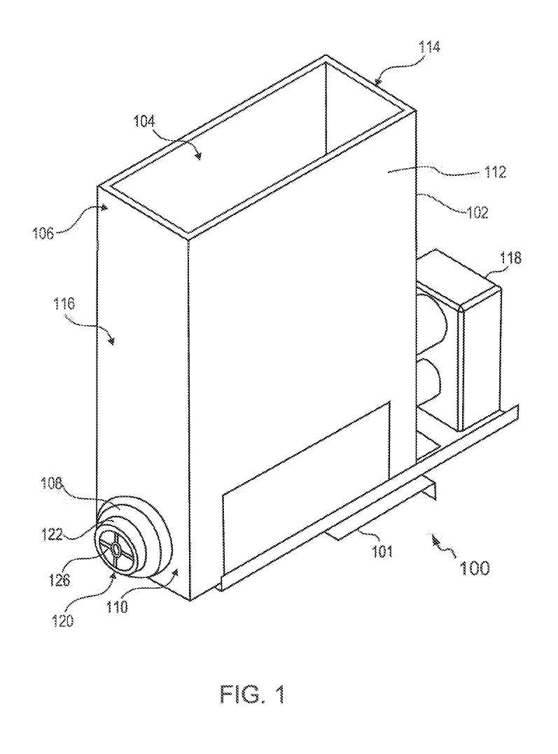

Various embodiments of an apparatus and methods for dispensing a powdered material such as flour are explained herein with reference to FIG. 1 to FIG. 6.

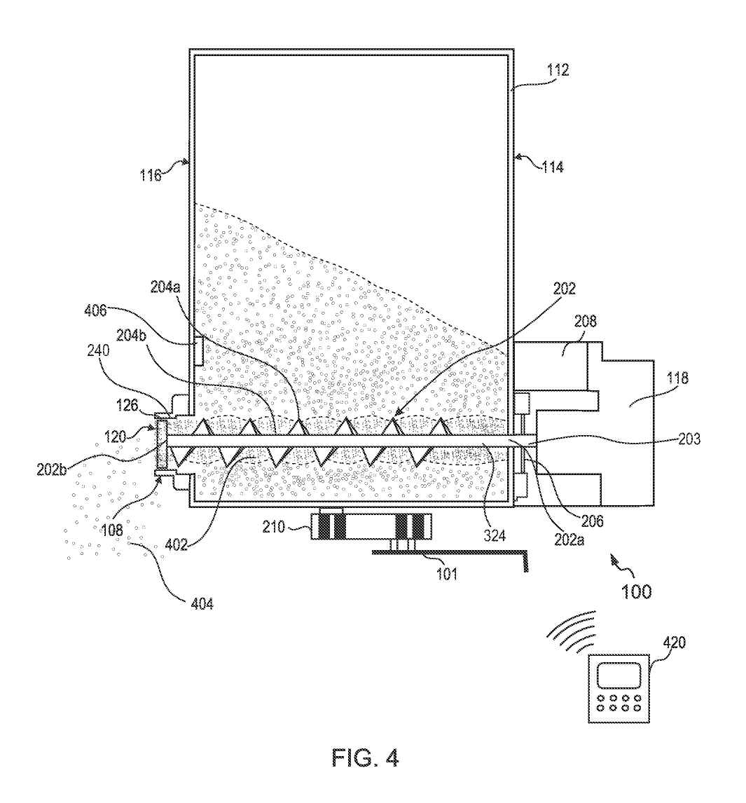

FIG. 1 in one exemplary embodiment of the present disclosure illustrates a perspective view of an apparatus 100 for dispensing a powdered material. The apparatus 100 is configured to scatter the powdered material (for e.g. see, (404) in FIG. 4) while dispensing the powdered material, so that the dispensed powdered material is devoid of chunks or lumps for e.g. see, 402 in FIG. 4, thereby ensuring accurate and precise dispensing of the powdered material.

The apparatus 100 includes a frame member 101 onto which a container 102 for storing the powdered material is mounted. The container 102 includes an inlet 104 provided on a top portion 106 of the container 102 for receiving the powdered material.

The container 102 also includes an outlet 108 provided on a bottom portion 110 of the container 102, for dispensing the powdered material.

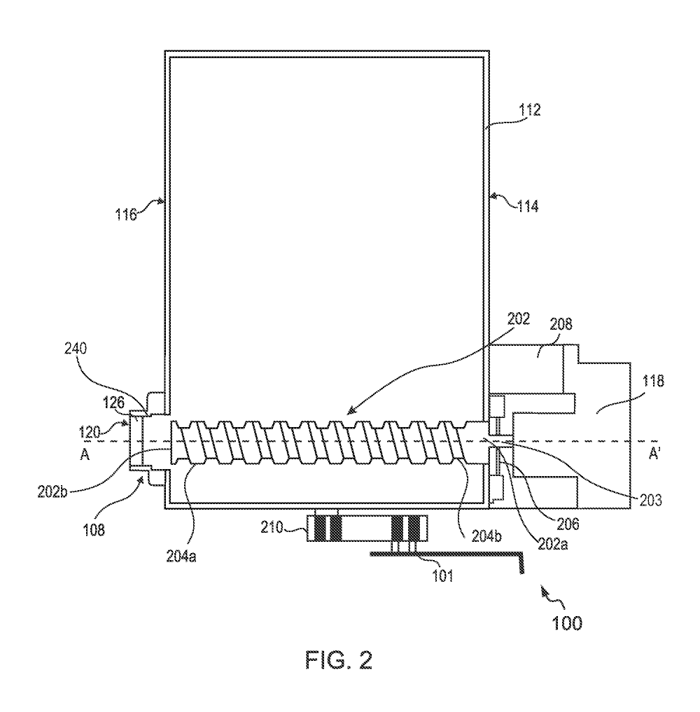

Referring to FIG. 2 in conjunction with FIG. 1, the apparatus 100 includes a screw conveyor member 202 disposed within the container 102. The screw conveyor member 202 is configured for conveying the powdered material from the container 102 to the outlet 108 for dispensing the powdered material. The screw conveyor member 202 includes a first end 202a rotatably mounted on a wall 112 of the container 102 and a second end 202b positioned proximal (for example, abuttingly positioned) to the outlet 108 of the container 102. Further, a rotational axis A-A′ of the screw conveyor member 202 is configured to coincide with the axis of the outlet 108. This configuration ensures that the screw conveyor member 202 is in-line with the outlet 108 thereby ensuring efficient dispensing of the powdered material from the container 102 through the outlet 108. In an embodiment, the first end 202a comprises a shank member 203 extending outwardly from the wall 112 of the container 102 and coupled to an actuator 118 for operation of the screw conveyor member 202.

In an embodiment, the screw conveyor member 202 may be disposed within the container 102, such that, the first end 202a of the screw conveyor member 202 is rotatably mounted to a rear portion 114 of the container 102, while the second end 202b is disposed close to or overlapping with the outlet 108 provided on a front portion 116 of the container 102. In an embodiment, the screw conveyor member 202 may be co-axial to the outlet 108. For example, the rotational axis A-A′ about which the screw conveyor member 202 rotates, passes through a central axis of the outlet 108. However, the axis A-A′ of the screw conveyor member 202 may not necessarily be co-axial to the outlet 108, and other configurations are also possible as long as the primary objective of conveying the flour close to or into the outlet 108 is achieved.

The screw conveyor member 202 is configured with a twist or spiral configuration defined by a plurality of crest regions 204a and a plurality of trough regions 204b. The trough regions 204b act as a bucket for collecting the powdered material, while the crest regions 204a act as a wall for the trough regions 204b. Such configuration of the screw conveyor member 202 ensures that the powdered material is retained within the trough regions 204b during operation of the screw conveyor member 202. Without limiting to the scope of the present disclosure, the screw conveyor member 202 may be selected from one of an auger or a lead screw as per feasibility and requirement.

Further, the screw conveyor member 202 is operable by the actuator 118 via the shank member 203 mounted to the frame member 101, so that the actuator 118 can axially rotate the screw conveyor member 202 (i.e. along the internal axis A-A′) for conveying the powdered material from the container 102 through the outlet 108. The actuator 118 is coupled to the first end 202a of the screw conveyor member 202 from the rear portion 114 of the container 102. The screw conveyor member 202 may be coupled to the actuator 118 by a mechanism including, but not limited to, a shaft coupling mechanism, or a gear mechanism or belt drive mechanism or any other mechanism as per design feasibility and requirement.

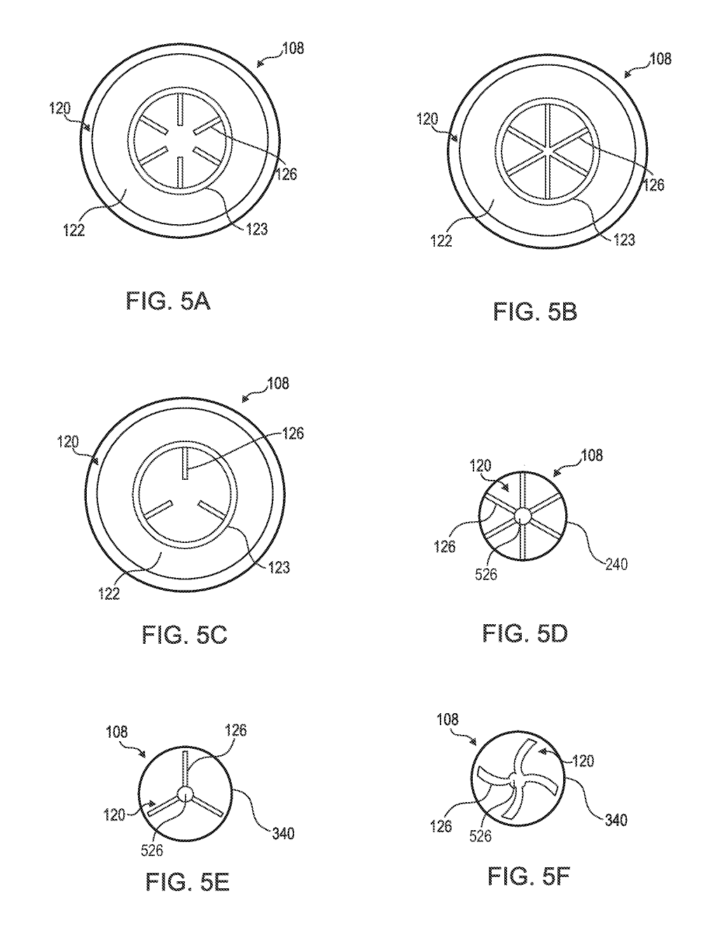

In some non-limiting embodiments, the scattering member 120 includes at least one obstruction (interchangeably referred to as “plurality of obstructions”) 126 configured to prevent dispensing of lumps (for e.g. see 402 in FIG. 4) of the powdered material conveyed by the screw conveyor member 202. The obstructions 126 may be a blade like structure, fins like structure, obstruction, or any structure which has means to break the lumps and openings to allow dispensing the powdered material after breaking the lumps. Some examples of the scattering member 120 are shown in FIGS. 5A to 5F.

Furthermore, as shown in FIG. 2, the apparatus 100 includes the scattering member 120 mounted to the outlet 108, such that, the ends of the obstructions 126 are secured to an inner wall 240 of the outlet 108, for instance, as shown in FIG. 5D. The scattering member 120 is at least partially positioned within the outlet 108 for scattering the powdered material routed through the outlet 108 by the screw conveyor member 202.

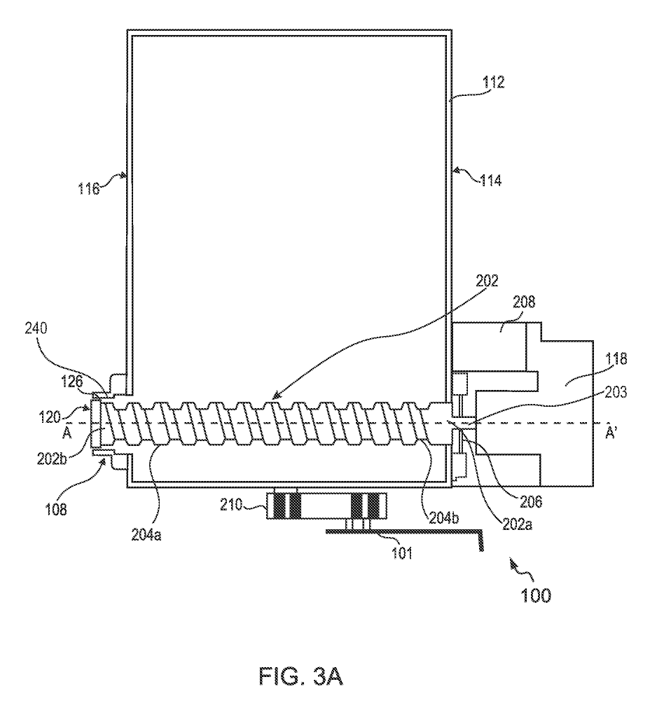

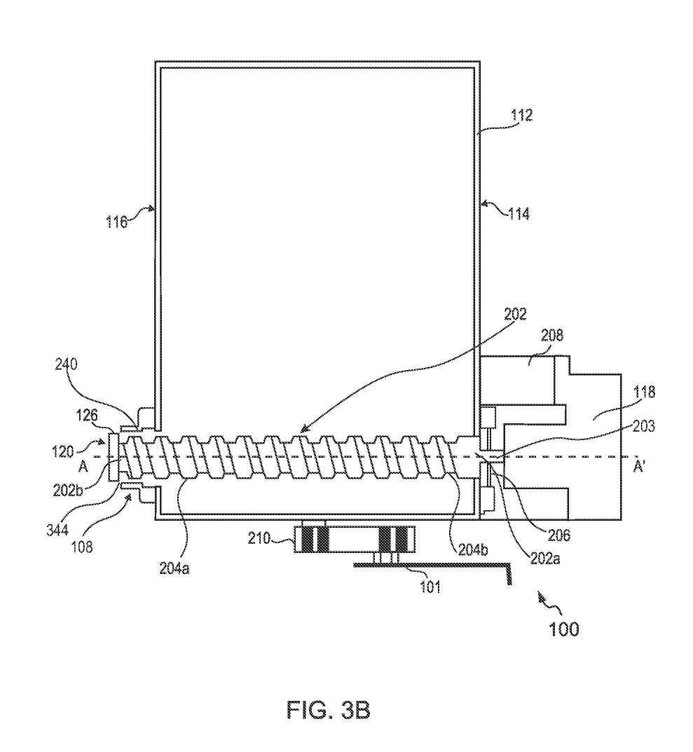

In another exemplary embodiment, as shown in FIG. 3A, the scattering member 120 is mechanically coupled (or mounted) to the second end 202b of the screw conveyor member 202 in a coaxial manner. The scattering member 120 is positioned proximal to the outlet 108 for scattering the powdered material routed through the outlet 108 by the screw conveyor member 202. In another non-limiting embodiment, as shown in FIG. 3B, the scattering member 120 may also be positioned completely outside of the outlet 108.

The specification of the scattering member 120 is such that, a clearance is maintained between the ends of the obstructions 126 and the inner wall 240 of the outlet 108, as illustrated in FIGS. 3A, 3B and 4. The clearance is provisioned for facilitation in rotation of both the scattering member 120 and the screw conveyor member 202 about rotational axis A-A′ of the screw conveyor member 202.

In another embodiment, as shown in FIG. 3B, the screw conveyor member 202 may be disposed within the container 102 such that, the second end 202b overlaps with the outlet 108 and may further extend from the outlet 108. The screw conveyor member 202 may be coaxial with outlet 108. The scattering member 120, which is mechanically coupled to the second end 202b of the screw conveyor member 202, may positioned completely outside the outlet 108. Note, in this configuration, the minimum gap (for e.g. as shown in FIG. 3B, as, 344) between the outlet 108 and the scattering member 120 is maintained horizontally. The gap 344 is maintained such that, each portion of the powdered material (mainly referred to as “lumps of the powdered material”) strikes through the scattering member 120 after dispensing from the outlet 108, thereby ensuring no lumps are further dispensed from the outlet 108 without being scattered or dispersed causing them to be broken into fine particles.

In an embodiment, the scattering member 120 may be releasably coupled to the second end 202b of the screw conveyor member 202 in a coaxial manner. Without loss of generality, the mechanical coupling of the scattering member 120 may be attachable and detachable with the second end 202b and can be of such as, but not limited to snap fit, fasteners and the like.

The scattering member 120 may be configured in a variety of ways. The primary purpose of the scattering member 120 is to scatter the flour conveyed by the screw conveyor member 202. In some non-limiting embodiments, the scattering member 120 may be designed by including the obstructions 126 in a variety of ways. Some exemplary configurations of scattering member 120 including the obstructions 126 are provided in FIGS. 5A to 5F. Although, the scattering member 120 are shown to be designed using the obstructions 126, however it can be understood that it can be designed with any such obstruction which breaks the lump formation in the flour.

In some embodiments, the scattering member 120 includes the housing 122. For instance, as shown in FIGS. 5A and 5B, six obstructions 126 are shown within the housing 122 mounted on inner wall 123 of the housing 122, and in FIG. 5C three obstructions 126 are shown within the housing 122. In an example, the obstructions 126 may perform as blades, which are extending radially towards the centre of the housing 122. Each of the blades acts as the means for scattering the lumps of the flour. The housing 122 is secured within the outlet 108 through mechanical means such that, it can be easily attached or detached with the outlet 108. The mechanical means can be of such as, but not limited to snap fit, fasteners and the like as per design feasibility and requirement.

In an embodiment, the scattering member 120 may be designed in a way such that, it can be directly mounted to the inner wall 240 of the outlet 108, for example as illustrated in FIG. 5D. The scattering member 120 comprises of an at least one obstruction 126, secured to the inner wall 240 of the outlet 108 coaxially. For instance, as shown in FIG. 5D, each ends of the six obstructions 126 is abuttingly connected to the inner wall 240 of the outlet 108. The scattering member 120 comprises a shaft 526 and a plurality of obstructions 126 mounted on the shaft 526 which extends radially away from the centre of the shaft 526 towards the inner wall 240 of the outlet 108. Other possible configurations can also work as long as the primary objective of scattering the flour passing through the scattering member 120 is achieved. Note, in this configuration, no housing 122 is provided which encompasses the plurality of obstructions 126.

In a non-limiting embodiment, the obstructions 126 are plates that may be extending angularly (or inclined) or radially towards the centre of the housing 122. It is noted that the obstruction 126 may be configured in one of a flat surface configuration (for e.g. as shown in FIGS. 5A to 5E), a twisted configuration (for e.g. as shown in FIG. 5F), an S-shaped configuration (not shown in Figures) and the like as per design feasibility and requirement.

The apparatus 100 also includes a load sensor 210 mounted on the frame member 101 and positioned below the container 102. The load sensor 210 is adapted to support the container 102 for measuring weight of the container 102. The load sensor 210 is electronically coupled to a control module 208 for periodically monitoring the weight of the container 102 during the dispensing of the powdered material. In an embodiment, the load sensor 210 is selected from one of a load cell, a strain gauge and the like as per design feasibility and requirement. In an embodiment, load sensor 210 is positioned below the container 102 such that, the entire weight of the apparatus 100 is balanced by the load sensor 210. In an embodiment, load sensor 210 may be positioned such that, the point of centre of mass of the apparatus 100 is collinear with the point of positioning of the load sensor 210.

Further, the apparatus 100 includes a rotary encoder 206 associated with the screw conveyor member 202 for monitoring the angular position of the screw conveyor member 202 during each of the plurality of rotating modes. The rotary encoder 206 is electronically coupled to the control module 208 and configured to send the determined angular position readings of the screw conveyor member 202 during operation in each of the plurality of rotating modes. The control module 208 is configured to receive readings from the rotary encoder 206 for controlling operation of the screw conveyor member 202 corresponding to the desired operation for each of the plurality of rotating modes.

The control module 208 is also electronically coupled to the actuator 118 for controlling an operating speed of the screw conveyor member 202. The control module 208 may control the operating speed of the screw conveyer member 202 by monitoring data received from the rotary encoder 206 and the load sensor 210. For instance, the control module 208 receives readings from the load sensor 210 and the rotary encoder 206, and based on the readings, controls the operation of the actuator 118. In an example, the control module 208 is adapted to monitor rotations of the screw conveyer member 202 based on Revolutions Per Minute (RPM) of the screw conveyer member 202. The control module 208 is adapted to control and monitor the dispensing of the powdered material from the container 102, based on the data (e.g., readings) received from each of the load sensor 210 and the rotary encoder 206.

The control module 208 is configured to determine the predetermined quantity of the powdered material, based on an input received from a user. After determining the predetermined quantity, the control module 208 is configured to compute the quantity of the powdered material within the container 102 based on the weight of the container 102, determined by the load sensor 210. After determining the quantity of the powdered material stored in the container 102 the control module 208 compares the quantity with the predetermined quantity, which is required to be dispensed. The control module sends a beep indication if the predetermined quantity of the powdered material configured to be dispensed is more than the volume of the powdered material stored in the container 102 measured based on weight measurement by the load sensor 210.

Furthermore, the control module 208 is configured to compute the predetermined quantity of the powdered material to be dispensed, and is configured to divide the predetermined quantity into a first portion, a second portion and a third portion. The control module 208 controls the operating speed of the screw conveyor member 202 such that, it is rotated in the plurality of rotating modes in a sequential manner. Each of the first portion, a second portion and a third portion is associated with each of the plurality of rotating modes which is further explained below in a detailed manner.

In a first mode of the plurality of rotating modes, the screw conveyor member 202 is operated at a first speed for dispensing the first portion. In this particular mode, the screw conveyor member 202 is operated by the control module 208 for a predetermined duration of time for dispensing the first portion of the predetermined quantity of the powdered material. The first speed may be the maximum speed of the screw conveyor member 202, and thus, the powdered material is dispensed from the container 102 at a faster rate. The first operation may also be called as a rough stage dosing of the powdered material or as a time-step for dispensing the powdered material, due to its time-dependent operation. In an embodiment, the screw conveyor member 202 may operate for a predetermined number of revolutions corresponding to the predetermined duration of time.

The control module 208 prior to initiation of the dispensing operation, computes the predetermined time required for dispensing the first portion. The control module 208 computes the predetermined quantity based on the inputs received from the user. The user may directly input the predetermined quantity to be dispensed or may provide inputs based on the device employed. That is, if the apparatus 100 is employed in the flatbread making apparatus 602, the user may input either the number of flatbreads required or the size of the flatbread required. Based on the input received and the pre-set computations stored within the control module 208, the predetermined quantity may be determined. As an example, if the predetermined quantity to be dispensed is 27 gms, the control module may consider 9 gms as the first portion. In this scenario, if the rate of dispensing of the powdered material by the screw conveyor member 202 is 1.5 gms per revolution, then the control module 208 computes that 6 revolutions are required for dispensing 9 gms. Accordingly, for dispensing the first portion, the control module operates the screw conveyor member 202 for 6 revolutions at the first speed which is high speed with respect to a second speed and a third speed explained below.

In a second mode of the plurality of rotating modes, the screw conveyor member 202 is again operated at a second speed for dispensing the second portion. In this particular mode, the screw conveyor member 202 is operated by the control module 208, until the second portion is determined by the control module 208 as already dispensed. The second portion of the predetermined quantity of the powdered material is measured by the load sensor 210, based on reduction in readings (e.g., changes in weight or weight difference) of the weight of the container 102.

The second operation is also the rough stage of dosing however the operation is weight dependent, rather than time dependent operation as in first operation. The operation may be carried out to eliminate error occurring due to vibrations in the device or any other mechanical factors during operation of the apparatus 100. In this stage, the control module 208 determines the remaining portion of the predetermined quantity to be dispensed and accordingly, computes the second portion. From the previous example in operation, the remaining quantity to be dispensed is 18 gms. Accordingly, the control module computes the second portion as 15 gms. Thus, the control module 208 operates the screw conveyor member 202 at a second speed, until the weight difference indicated by the load sensor 210 is 15 gms. The second speed is selected to be slower than that first speed, for higher accuracy of dispensing the powdered material and, for greater control over operation of the screw conveyor member 202.

In a third mode of the plurality of rotating modes, the screw conveyor member 202 is operated at a third speed for dispensing the third portion. In this particular mode, the screw conveyor member 202 is operated by the control module 208 in an intermittent manner, until the third portion is determined by the control module 208 based on the weight measured by the load sensor 210 as dispensed. Further, this portion is divided into a plurality of sub-portions and after dispensing of each of the plurality of sub-portions, which is done by the screw conveyer member 202 operating intermittently, the weight of the container 102 is subsequently measured, by the load sensor 210. The quantity of each of the subsequent sub-portion with respect to its predecessor sub-portion is specifically reduced, for substantially reducing error in dispensing the third portion. In other words, the quantity of each of the subsequent sub-portion is reduced in gradual and precise manner, for increasing the accuracy while dispensing the each sub-portion.

The third portion is the remainder portion of the predetermined quantity of the powdered material (i.e. 3 gms as per the previous example). The control module 208 is configured to operate the screw conveyor member 202 intermittently for dispensing the third portion, for precisely dispensing the third portion. In each interval of the intermittent operation of the screw conveyor member 202, the screw conveyor member 202 is maintained in an idle state, to enable the load sensor 210 to measure current weight of the container 102. Upon measurement of the weight, the operation of the screw conveyor member 202 is resumed. As an example, the control module 208 may monitor the weight of the container 102 every half a revolution of the screw conveyor member 202. Based on this pre-set instruction, the control module 208 continues the process until 3 gms of the powdered substance is dispensed. Due to the intermittent or cyclic operation of the screw conveyor member 202, the powdered material is accurately dispensed from the container 102.

The control module 208 is communicably coupled to the mobile communication device 420 of a user for providing an indication signal, when the quantity of the flour is below predetermined quantity of the powdered material. The indication signal comprises an alert message, stating unavailability of adequate amount of the flour for dispensing the predetermined quantity of the flour

In an embodiment, the load sensor 210 is configured to determine the weight of the flour based on measuring the weight of the container 102. Without loss of generality, the weight of the flour is computed by subtracting weight of the container 102, when the flour is empty from the weight of the container 102 containing the flour. Note, other possible variations may also be incorporated for computing the weight of the flour by the load sensor 210.

In an embodiment, the control module 208 may determine the quantity of the powdered material dispensed per revolution of the screw conveyer member 202, prior to initiation of the dispensing operation of the apparatus 100. In this scenario, the control module 208 may operate the screw conveyer member 202 for one revolution and thereupon, determine the quantity of the powdered material dispensed, based on the difference in weight determined by the control module 208 based on readings received from the load sensor 210.

In an embodiment, shape of the container 102 may be selected from one of cylindrical shape, cubical shape, rectangular shape or any other shape as per design feasibility and requirement.

In an embodiment, the proximity or distance between the second end 202b and the outlet 108 may be selected such that, the powdered material is routed through the outlet 108 upon operation of the screw conveyor member 202. The screw conveyor member 202 while maintaining the proximity or abutting position with the outlet 108, routes the powdered material due to agitation of the powdered material surrounding the screw conveyor member 202.

In an embodiment, the second end 202b of the screw conveyor member 202 can be positioned within the outlet 108 (for e.g. as shown in FIGS. 2 and 3A), for efficient dispensing of the powdered material from the container 102.

In an embodiment, the second end 202b of the screw conveyor member 202 can also be positioned outside the outlet 108 (for e.g. as shown in FIG. 3B), for efficient dispensing of the powdered material from the container 102.

In an embodiment, the screw conveyer member 202 can be of a configuration of the auger having the twist or spiral configuration. The augur includes a plurality of blades defined on a shaft 324 (for e.g. as shown in FIG. 4). The crest regions 204a may be defined as the distance from the shaft 324 up to the tip of the blades and the trough regions 204b may be the region in between the blades. In an embodiment, the configuration of each of the blades may be selected to be an S-shaped configuration, a flat-shaped configuration or any other configuration as per feasibility and requirement. In an embodiment, the blades can be configured to define the configuration of each of the crests 204a and each of the troughs 204b, such as a width of each the troughs 204b, a height of each of the crests 204a and the like. The twist configuration defines volume of the powdered material dispensed through the outlet 108 per rotation of the screw conveyor member 202.

In an embodiment, the screw conveyor member 202 can be the lead screw including screw threads for defining the twist or spiral configuration. The screw threads may be selected from one of a V-thread configuration, an acme-thread configuration and the like as per feasibility and requirement. In an embodiment, the screw threads can be configured to define configuration of each of the crests 204a and each of the troughs 204b, such as the width of each of the troughs 204b, the height of each of the crests 204a and the like. The configuration of the screw threads defines rate of volume of the powdered material dispensed through the outlet 108 per rotation of the screw conveyor member 202.

In an embodiment, the actuator 118, coupled to the screw conveyor member 202 may be selected from one of a motor, a hydraulic actuator and a pneumatic actuator. In the event of use of the hydraulic actuator or the pneumatic actuator for operating the screw conveyor member 202, appropriate mechanism such as the gear arrangement, belt-drive arrangement and the like, may be incorporated for efficient transfer of torque from the actuator 118 to the screw conveyor member 202.

In an embodiment, the apparatus 100 may also include a sensor 406 (shown in FIG. 4) for detecting the level of the powdered material contained within the container 104. The sensor 406 may be based on techniques such as image sensing, optical sensing techniques, and the like. The sensor 406 may be configured to alert the control module 208 when the level in the container 102 falls below a threshold level. The threshold level may be a level below the screw conveyer member 202.

In an embodiment, as shown in FIG. 4 control module 208, may be communicably coupled to the mobile communication device 420 associated with a user. The control module 208 may sends a wireless signal to the mobile communication device 420 associated with a user for notifying the user regarding a need to refill the container 102, when the level in the container 102 falls below a threshold level.

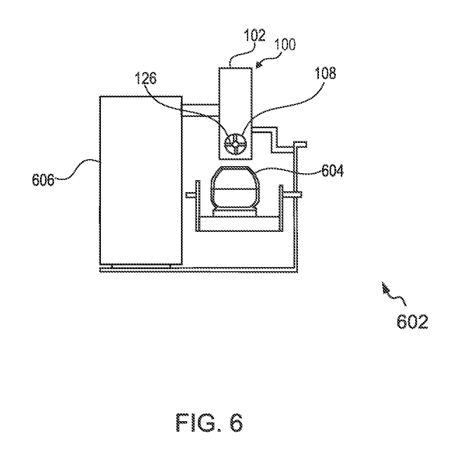

Referring to FIG. 6, the flatbread making apparatus 602 for preparing flatbreads, including the apparatus 100 for dispensing the flour into a mixer unit 604 is illustrated. The mixer unit 604 is juxtaposed below the container 102 for receiving the scattered flour. In this scenario, the apparatus 100 may be configured to dispense the flour based on an input received from a user. The input may be one of a number of flatbreads, the size of the flatbreads to be prepared and the like. The container 102 of the apparatus 100 is configured to dispense the flour according to the inputs received from the user, so that the flatbread making apparatus 602 can knead the flour in the mixer unit 604 to form a doughball. The doughball is further processed in a mechanism 606 of the flatbread making apparatus 602 for flattening the dough ball and baking the flatbreads.

Furthermore, the control module 208 is configured to compute the predetermined quantity of the flour to be dispensed, and to divide the predetermined quantity into a first portion, a second portion and a third portion. The control module 208 controls the operating speed of the screw conveyor member 202 such that, it is rotated within the plurality of rotating modes. Each of the first portion, the second portion and the third portion is associated with the first speed, the second speed and the third speed. The control module is configured to dispense the predetermined quantity of the flour by operating the screw conveyer member in a plurality of rotating modes.

In another embodiment, the control module 208 may include predefined computation values or instructions corresponding to one of the apparatus 100 in which the control module 208 may be mounted. This configuration of the control module 208 ensures immediately controlling the apparatus 100, without the need for trial testing. As an example, the control module 208 may be programmed to control the apparatus 100 installed in a flatbread making apparatus 602. In this scenario, the control module 208 may store values pertaining to dispensing of the flour per revolution of the screw conveyor member 202 from the container 102, quantity of the flour to be dispensed and the like. Thus, in this configuration, the control module 208 may readily control dispensing operation of the apparatus 100.

The sequence of operations described above may not be necessarily executed in the same order as they are presented. Further, one or more operations may be grouped together and performed in form of a single operation, or one operation may have several sub-operations that may be performed in parallel or in a sequential manner.

Various example embodiments of the present disclosure described herein, with reference to various schematic views and flow diagrams, are for illustrative purposes and provided numerous advantages and technical effects. For instance, the apparatus is configured to scatter the powdered material while dispensing, thereby preventing dispensing of chunks of the powdered material. The prevention of dispensing of chunks inherently improves the accuracy and the precision of dispensing of the powdered material. Additionally, the apparatus is scalable, modular and inexpensive.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims.

What is claimed is:

1. An apparatus for dispensing a powdered material, comprising:
a container for storing the powdered material, the container comprising an inlet for receiving the powdered material and an outlet for dispensing the powdered material;
a screw conveyor member disposed within the container, the screw conveyor member comprising a first end rotatably mounted on a wall of the container and a second end abuttingly positioned to the outlet, wherein the screw conveyor member is operable by an actuator for conveying the powdered material through the outlet of the container;
a scattering member comprising at least one obstruction, the scattering member coupled to the outlet for scattering the powdered material while dispensing the powdered material from the outlet of the container;
a load sensor adapted to support the container for measuring weight of the container; and
a control module adapted to control operating speed of the actuator to operate the screw conveyor member in a plurality of rotating modes based on weight readings received from the load sensor for controlling dispensing of the powdered material based on the plurality of rotating modes.

2. The apparatus as claimed in claim 1, further comprising a rotary encoder associated with the screw conveyer member and electronically coupled to the control module, the rotary encoder adapted to determine angular position of the screw conveyor member during each of the plurality of rotating modes.

3. The apparatus as claimed in claim 2, wherein the control module is configured to receive readings from the rotary encoder for controlling operation of the screw conveyor member in each of the plurality of rotating modes.

4. The apparatus as claimed in claim 1, wherein the scattering member comprises a housing disposed within the outlet and at least one obstruction mounted to inner wall of the housing.

5. The apparatus as claimed in claim 1, wherein configuration of each of the at least one obstruction comprises one of a flat surface configuration, a twisted configuration and an S-shaped configuration.

6. The apparatus as claimed in claim 1, wherein the load sensor is mounted on a frame member.

7. The apparatus as claimed in claim 1, wherein the control module is configured to compute a predetermined quantity of the powdered material configured to be dispensed, and to divide the predetermined quantity into a first portion, a second portion and a third portion,
wherein in a first mode of the plurality of rotating modes, the first portion is dispensed, by operating the screw conveyor member for a predetermined duration of time;
wherein in a second mode of the plurality of rotating modes, the second portion is dispensed, by operating the screw conveyor member until the second portion is determined by the control module, based on changes in readings provided by the load sensor based on difference in the weight of the container; and
wherein in a third mode of the plurality of rotating modes, the third portion is dispensed by operating the screw conveyor member intermittently, until the third portion is determined by the control module, based on changes in the readings provided by the load sensor based on difference in the weight of the container.

8. The apparatus as claimed in claim 7, wherein the screw conveyor member is operated at a first speed, a second speed and a third speed for the first mode, the second mode, and the third mode of the plurality of rotating modes, respectively.

9. The apparatus as claimed in claim 7, further comprising, dispensing of the first portion, by operating the screw conveyor member for a predetermined number of revolutions corresponding to the predetermined duration of time.

10. The apparatus as claimed in claim 7, wherein the control module is further configured to divide the third portion into a plurality of sub-portions and subsequently monitoring, by the load sensor, the weight of the container upon dispensing of each of the plurality of sub-portions by the screw conveyor member, until the third portion of the predetermined quantity is dispensed from the container.

11. An apparatus for dispensing a powdered material, comprising:
a container for storing the powdered material, the container comprising an inlet for receiving the powdered material and an outlet for dispensing the powdered material;
a screw conveyor member disposed within the container, the screw conveyor member comprising a first end rotatably mounted on a wall of the container and a second end positioned juxtaposed to the outlet, wherein the screw conveyor member is operable by an actuator for conveying the powdered material through the outlet of the container; and
a scattering member comprising a plurality of obstructions and coupled to the second end of the screw conveyer member, wherein the scattering member is positioned proximal to the outlet for scattering the powdered material while dispensing the powdered material from the outlet of the container;
a load sensor adapted to support the container for measuring weight of the container;
a control module adapted to control operating speed of the actuator for operating the screw conveyor member in a plurality of rotating modes based on weight readings received from the load sensor for controlling dispensing of the powdered material based on the plurality of rotating modes; and
a rotary encoder coupled to the screw conveyer member for determining angular position of the screw conveyor member during each of the plurality of rotating modes, wherein the rotary encoder is electronically coupled to the control module for sending readings, for controlling operation of the screw conveyor member.

12. The apparatus as claimed in claim 11, wherein the second end projects outwardly from the outlet such that, the scattering member is positioned completely outside the outlet.

13. The apparatus as claimed in claim 11, wherein a clearance is maintained between ends of each of the plurality of obstructions and an inner wall of the outlet for permitting rotation of both the scattering member and the screw conveyor member.

14. The apparatus as claimed in claim 11, further comprises a sensor, for detecting level of the powdered material within the container and electronically coupled to the control module for sending signal, when the level in the container falls below a threshold level.

15. The apparatus as claimed in claim 14, wherein the control module is communicably coupled to a mobile communication device associated with a user for sending a wireless signal for notifying the user regarding a need to refill the container, when the level in the container falls below the threshold level.

16. The apparatus as claimed in claim 11,
wherein the control module is configured to compute a predetermined quantity of the powdered material configured to be dispensed, and to divide the predetermined quantity into a first portion, a second portion and a third portion,
wherein in a first mode of the plurality of rotating modes, the first portion is dispensed, by operating the screw conveyor member for a predetermined duration of time;
wherein in a second mode of the plurality of rotating modes, the second portion is dispensed, by operating the screw conveyor member until the second portion is determined by the control module, based on changes in readings provided by the load sensor based on difference in the weight of the container; and
wherein in a third mode of the plurality of rotating modes, the third portion is dispensed, by operating the screw conveyor member intermittently, until the third portion is determined by the control module, based on changes in the readings provided by the load sensor based on the difference in the weight of the container.

17. A flatbread making apparatus, comprising:
an apparatus for dispensing flour, comprising:
a container for storing the flour, the container comprising an inlet for receiving the flour and an outlet for dispensing the flour,
a screw conveyor member disposed within the container, the screw conveyor member comprising a first end a rotatably mounted on a wall of the container and a second end positioned within the outlet, wherein the screw conveyor member is operable by an actuator for conveying the flour through the outlet of the container,
a scattering member at least partially disposed within the outlet and coupled to the second end of the screw conveyer member, the scattering member comprising a plurality of obstructions for scattering the flour while dispensing the flour from the outlet of the container,
a load sensor adapted to support the container for measuring weight of the container, and
a control module adapted to control operating speed of the actuator to operate the screw conveyor member in a plurality of rotating modes based on weight readings received from the load sensor for controlling dispensing of the flour based on the plurality of rotating modes;
a mixer unit juxtaposed below the container, the mixer unit configured to receive the scattered flour routed through the outlet of the container and to knead the scattered flour into a doughball; and
a mechanism to bake flatbread from the doughball received from the mixer unit.

18. The apparatus as claimed in claim 17,
wherein the control module is configured to compute a predetermined quantity of the flour configured to be dispensed, and to divide the predetermined quantity into a first portion, a second portion and a third portion,
wherein in a first mode of the plurality of rotating modes, the first portion is dispensed, by operating the screw conveyor member for a predetermined duration of time;
wherein in a second mode of the plurality of rotating modes, the second portion is dispensed, by operating the screw conveyor member until the second portion is determined by the control module, based on changes in readings provided by the load sensor based on difference in the weight of the container; and
wherein in a third mode of the plurality of rotating modes, the third portion is dispensed, by operating the screw conveyor member intermittently, until the third portion is determined by the control module, based on changes in the readings provided by the load sensor based on the difference in the weight of the container.
